(19) United States
(12) Patent Application Publication
(10) Pub. No.: US 2008/0103239 A1
(43) Pub. Date: May 1, 2008

(54) Radically Crosslinkable Hydrogel Comprising Linker Groups

(76) Inventors: Philippe Arquint, Bonaduz (CH); Hans-Dieter Feucht, Renningen (DE); Walter Gumbrecht, Herzogenaurach (DE); Hannelore Nuss, Stuttgart (DE)

Correspondence Address: HARNESS, DICKEY & PIERCE, P.L.C., P.O.BOX 8910, RESTON, VA, 20195, US

(21) Appl. No.: 10/523,933

(22) PCT Filed: Jul. 29, 2003
(86) PCT No.: PCT/DE03/02548

§ 371 Date: Aug. 1, 2007

(30) Foreign Application Priority Data
Aug. 8, 2002 (DE) 102 36 461.3

(51) Int. Cl. C08K 5/05; C08L 33/26

(52) U.S. Cl. 524/389; 524/379

(57) ABSTRACT

A radically crosslinkable liquid composition is for producing a polyacrylamide-based hydrogel layer. The composition includes at least one comonomer with reactive linker groups and at least one optional softener in addition to the monomer precursor of the polyacrylamide, the crosslinking agent, and the radical initiator(s).

This application is the national phase under 35 U.S.C. § 371 of PCT International Application No. PCT/DE2003/002548 which has an International filing date of Jul. 29, 2003, which designated the United States of America and which claims priority on German Patent Application number DE 102 36 461.3 filed Aug. 8, 2002, the entire contents of which are hereby incorporated herein by reference.

### FIELD OF THE INVENTION

The present invention generally relates to radically crosslinkable liquid compositions for producing a hydrogel based on polyacrylamide.

### BACKGROUND OF THE INVENTION

So-called biochips are increasingly being used in modern biological analysis technology as well as in medical diagnostics. Biochips are mostly planar carrier systems made from glass or plastic, the surface of which is equipped with a two-dimensional recognition layer comprising biological recognition molecules. A known example for a biochip of this type is the optical DNA chip which can be read-out, the biochip being described by F. Hanel, H .P Saluz in BIOforum 9/99, pages 504-507.

The use of three-dimensional immobilization layers for biological recognition molecules is expedient in order to increase the sensitivity of this type of biochip and to optimize the reproducibility of the measurement results. Schleicher & Schuell GmbH use a three-dimensional immobilization layer for a product called FAST™ Slides DNA chips, in which capture oligos are immobilized in a three-dimensional nitrocellulose membrane (Schleicher & Schuell, Biomolecular Screening, Catalogue 2001 (International Edition)).

One problem with the technical realization of corresponding immobilization layers is firstly the desire to achieve a cost-effective method for applying the layers onto the chips or the transducer systems. The immobilization systems made from liquid precursors are dripped onto a suitable base, dispensed, hydroextracted or imprinted thereon. Thermal polymerization and/or crosslinking, drying processes or photochemical polymerization processes and/or crosslinking processes are chosen to solidify the layers.

Ph. Arquint describes a photo-crosslinked hydrogel based on a crosslinked polyacrylamide for this type of application (‘Integrated Blood Gas Sensor for pO2, pC02 and pH based on Silicon Technology (Dissertation, Ph. Arquint. University of Neuchatel, Switzerland, 1994).

Hydrogels play a significant role in the chemical and/or biological analysis and particularly in the realization of chemosensors and biosensors. Their function is to realize a watery environment in a mechanically stable form at the same time as guaranteeing the exchange of materials in a predominantly watery environment. By selecting the chemical composition concerning the components and their ratios among one another, the properties of the hydrogels, such as the water content, swelling behavior, mechanical stability etc. can be varied over large areas.

In his dissertation, Ph. Arquint describes a method whereby polyacrylamide hydrogels are applied to silicon wafers and phototechically structured by means of an approximately semiconductor compatible method. Nevertheless one decisive problem exists with the technology described:

One disadvantage of the system described by Arquint, i.e the hydrogel precursor, can be seen in that no reactive linker groups are available in the crosslinked layer, said linker groups allowing chemical or biological recognition molecules to be coupled for analytical applications.

In Nucleic Acids Research, 1966, Volume 24, No. 16, pages 3142-3148 Timofeev et al. describe a chemically modified radically crosslinked polyacrylamide, which can be used, among other things, for the immobilization of capture oligos. Amino and aldehyde groups are used as coupling groups in the hydrogel. Aldehyde and/or amino functionalized capture oligos can be immobilized covalently on these coupling groups subject to reductive reaction conditions. Thus, an additional reduction step is required using a reduction device/method, in addition to the actual coupling reaction between amino and/or aldehyde groups or vice versa. Further methods described by Timofeev et al. for the chemical activation of the crosslinked polyacrylamide similarly require additional reaction steps in the polymer matrix.

### SUMMARY OF THE INVENTION

An object of an embodiment of the present invention is thus to provide a radically crosslinkable acrylamide-based hydrogel system, which contains a comonomer which enables the covalent coupling of correspondingly modified biomolecules, in other words, chemical or biological recognition molecules with compatible linker groups, across a reactive linker group in a simple, rapid reaction step, without the use of any additional chemicals.

### DETAILED DESCRIPTION OF THE EXEMPLARY EMBODIMENTS

The subject-matter of an embodiment of the present invention is consequently a radically crosslinkable liquid composition for producing a polyacrylamide-based hydrogel layer, which stands out in that the composition comprises at least one comonomer with reactive linker groups and at least one optional softener in addition to the monomer precursor of the polyacrylamide, the crosslinking agent, and the radical initiator(s).

A water-swellable hydrogel is achieved after manufacturing the layer and the thermal and/or photo crosslinking, said hydrogel containing reactive linker groups to immobilize chemical or biological recognition molecules for analytical or diagnostic applications.

The monomer precursor of the polyacrylamide is based on acrylamide and methylenebisacrylamide, whereby two monomer chains are connected to one another as with Arquint. By varying the concentration of the crosslinking agent methylenebisacrylamide, dimethylacrylic acid ester, such as tetraethylene glycol dimethacrylate, for example, the mesh size of the hydrogel can be easily adjusted.

The comonomer with reactive linker groups is preferably selected from the group comprising maleic acid anhydride and/or glycidyl methacrylate. The softener is preferably monoethylene glycol, diethylene glycol or triethylene glycol. By optimizing the softener content in the composition, the dried precursor layer can be optimized in its polymerization behavior.

The composition is preferable in a polar solvent which can be mixed with water, preferably dimethyl formamide. The processing viscosity can be easily adjusted by varying the solvent content.

The composition according to an embodiment of the invention offers numerous advantages for the production of hydrogels, in particular those which are to be used for producing immobilization layers. The precursor components can be mixed in a widely variable mixing ratio. The viscosity of the composition can be easily adjusted. A good layer formation is guaranteed during which no phase separation takes place. The layer is sufficiently transparent for light for the photoinitiation.

Crosslinking density and water swelling capacity can be arbitrarily adjusted. The auxiliary components such as the softener etc, can be easily washed out after the crosslinking. The adhesion to the substrate surface can be strengthened by means of conventional adhesion promoter systems based on silicon for example.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. Radically crosslinkable liquid composition for producing a polyacrylamide-based hydrogel layer, comprising:
at least one comonomer with reactive linker groups; and
a monomer precursor of the polyacrylamide, a crosslinking agent and a radical initiatior.

2. Composition according to claim 1, wherein
the monomer precursor of the polyacrylamide is at least one of based on acrylamide methylenbis(meth)acrylamide and dimethacrylic acid ester.

3. Composition according to claim 1, wherein
the comonomer with reactive linker groups includes at least one of maleic acid anhydride and glycidyl (meth)acrylate.

4. (canceled)

5. Composition according to claim 1, wherein
composition is available in a polar solvent, and is mixable with water.

6. Composition according to claim 5, wherein
the solvent is dimethyl formamide.

7. A method, comprising:
using a composition according to claim 1 to produce an immobilization layer for biomolecules on a transducer surface.

8. Composition according to claim 1, further comprising at least one softener.

9. Composition according to claim 1, further comprising at least one optional softener.

10. Composition according to claim 2, wherein the comonomer with reactive linker groups is selected from the group comprising maleic acid anhydride and glycidyl (meth)acrylate.

11. Composition according to claim 8, wherein the softener includes at least one of monoethylene glycol, diethylene glycol and triethylene glycol.

12. Composition according to claim 1, wherein the softener includes at least one of monoethylene glycol, diethylene glycol and triethylene glycol.

13. Composition according to claim 2, wherein the composition is available in a polar solvent, and is mixable with water.

14. Composition according to claim 13, wherein the solvent is dimethyl formamide.

15. Composition according to claim 3, wherein the composition is available in a polar solvent, and is mixable with water.

16. Composition according to claim 15, wherein the solvent is dimethyl formamide.

17. A method, comprising:
using a composition according to claim 2 to produce an immobilization layer for biomolecules on a transducer surface.

18. A method, comprising:
using a composition according to claim 3 to produce an immobilization layer for biomolecules on a transducer surface.

19. A method, comprising:
using a composition according to claim 5 to produce an immobilization layer for biomolecules on a transducer surface.

20. A method, comprising:
using a composition according to claim 6 to produce an immobilization layer for biomolecules on a transducer surface.
